(19) United States
(12) Patent Application Publication
(10) Pub. No.: US 2009/0314505 A1
(43) Pub. Date: Dec. 24, 2009

(54) Drill attachment device

(76) Inventor: Jody T. Jenkins, Newton, UT (US)

Correspondence Address: KEELY SCHNEITER, 399 NORTH MAIN, SUITE 300, LOGAN, UT, 84321, US

(21) Appl. No.: 12/214,948

(22) Filed: Jun. 24, 2008

(51) Int. Cl. B25B 21/00; B25B 13/06

(52) U.S. Cl. 173/29; 81/121.1

(57) ABSTRACT

An attachment device for a drill includes a drill adapter configured to attach to a drill, an extension member, and a leading portion. The leading portion of the attachment device is configured to engage a threaded rod, such that when the drill adapter is attached to a drill, the leading portion of the attachment device moves the device up the piece of threaded rod, thus allowing placement of nuts at various heights along a lengthy piece of threaded rod.

### BACKGROUND OF THE INVENTION

1. The Field of the Invention

This invention relates generally to electrical cabling. More particularly, this invention relates to equipment used in installation of electrical cabling structures.

2. Related Technology

The electrical wiring that runs through buildings, homes, and other structures includes numerous types of cables and wires. For example, the wiring in many buildings may include fiber optic cabling and insulated wiring. This electrical wiring runs through pathways between electrical devices in a building. These pathways may be in the form of an electrical conduit, or in one of several different varieties of tubing, or in many other forms. Wires that run underground, for example, may be contained in plastic tubing and further encased in concrete, while in exposed areas of buildings wiring may be run in cable trays.

Cable trays are most often used in industrial wiring applications where many insulated cables and/or wires are run together. The cable trays usually have one of two designs: an open ladder design or a solid back design. One advantage of the open ladder design is that such a design allows cables to exit the tray at any point; this design provides an easy way for cables to be routed as a single unit while at the same time allowing individual cables to leave the tray to be routed as required. Cable trays can be designed for any type of cable and to fit any design and material need. For example, cable trays can be manufactured of lightweight material for applications including holding fiber optic cables.

Cable trays require supports in order to be used in buildings. Cable trays are most often supported by channel-shaped side rails formed of galvanized steel. Several different support configurations are used with the side rails to support the cable trays. For example, these support configurations for cable trays include trapeze supports (single or multi-tier), hanger rod clamps or “J” hangers, center hung supports, wall supports, underfloor supports, and pipe stanchions or other structures. Each support method may be preferable depending on the desired application. For example, wall supports and underfloor supports are useful when ceiling structure is not available or not desired.

Center hung supports are typically used when cables will be installed from the side of the cable tray. Such a configuration may be especially useful when future cable additions are likely. Like center hung supports, trapeze supports hang from the ceiling and support the cable trays from above. Trapeze supports may be especially useful when cables will be pulled through the cable tray and routed to different destinations. Both center hung supports and trapeze supports utilize a threaded rod of a suitable diameter, such as, for example, ¼″, ⅜″, ½″, ⅝″ and ¾″, which can be several feet in length, and both support methods may use side rails upon which the cable trays rest.

Many innovations with regard to routing insulated wiring and the use of cable trays have helped to facilitate configurations of cable tray wiring systems. For example, cable trays are designed in many different ways and of many different materials to decrease their weight and otherwise improve that functionality. Cable rollers have been introduced to enable smooth turns when routing cable through cable trays. Moreover, many different innovations have been made with regard to hardware for trapeze and center support systems.

Limited innovations, however, exist in relation to the installation of cable tray and other wiring systems. Great difficulty is still encountered in installing cable trays and cable tray support systems. For example, installation of cable trays and side rails for trapeze and center support systems presents difficulties in placing nuts along the threaded rod used in these systems. Placement of nuts at appropriate locations along the threaded rod is both difficult and time consuming. What is needed are systems and methods for facilitating correct placement of nuts along the lengthy threaded rods used in the wiring applications described above.

### BRIEF SUMMARY OF THE INVENTION

Embodiments of the present invention include devices for efficiently placing nuts along threaded rods with varying diameters and lengths up to several feet. A drill extension device having a drill adapter end and a nut retention end facilitates placement of nuts along a threaded rod. The drill adapter end engages a conventional drill and also attaches to an extension portion of the device. The extension portion further connects to a nut retention end of the device. After being secured to a drill, the device engages a threaded rod, substantially surrounding the rod, and the nut is placed at the desired position along the rod. In one embodiment of the invention, multiple nuts may be placed at different positions along the rod, without having the remove the device and insert additional nuts into the nut retention end of the device.

These and other aspects of the present invention will become more fully apparent from the following description and appended claims, or may be learned by the practice of the invention as set forth hereinafter.

### BRIEF DESCRIPTION OF THE DRAWINGS

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings are not drawn to scale. The invention will be described and explained with additional specificity and detail through the use of the accompanying drawings in which:

FIG. 1 shows an isometric view of the drill device;

FIGS. 2A and 2B show the drill adapter end of the device; and

FIGS. 3A and 3B show the nut retention end of the device.

### DETAILED DESCRIPTION OF EXEMPLARY EMBODIMENTS

Embodiments of the present invention include a drill device having a drill adapter, an extension member, and a leading portion. The drill adapter is configured to attach to a drill and also to engage the extension member. The extension member further connects to the leading portion of the device, which may include a receiving end for holding a nut. In applications where placement of a nut along an extended piece of threaded rod is required, the threaded rod is inserted through the leading portion of the device. The drill adapter is connected to a drill and the drill moves the device up the rod. As the device is moved up the rod, the extension member and leading portion, the leading portion including one or more nuts to be positioned along the rod, surround the rod. The one or more nuts are placed along the threaded rod and the device is removed. As support rails and other equipment and materials are added to the system, and the drill device is used to secure nuts that hold these items in place along the threaded rod.

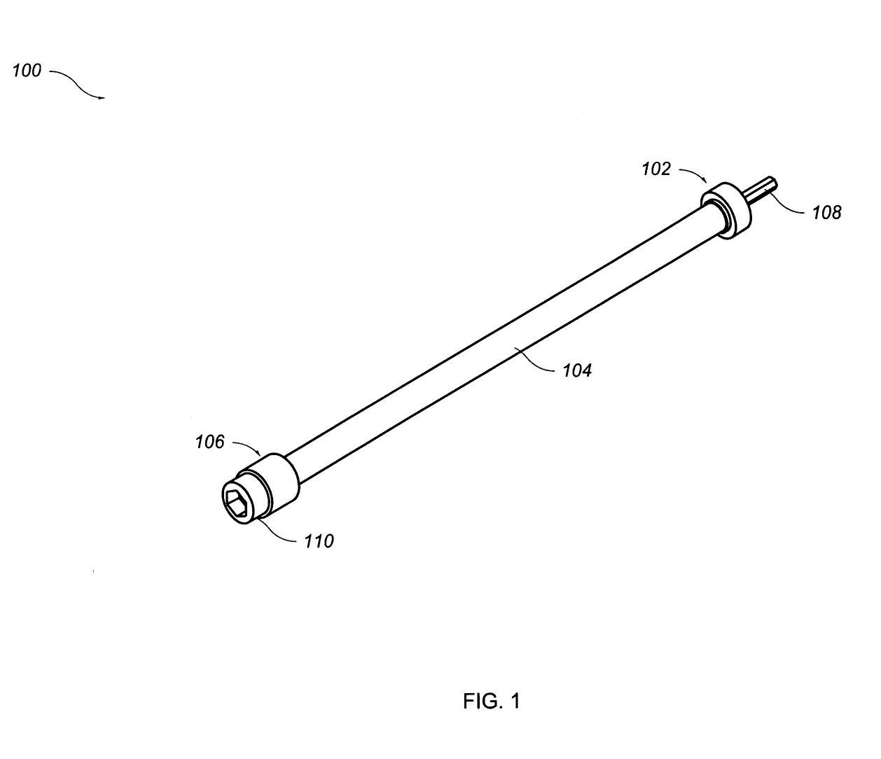

With attention now to FIG. 1, an isometric view of drill device 100 is shown. Drill device 100 includes drill adapter 102, extension member 104, and leading portion 106. A first end 108 of drill adapter 102 is configured to engage a drill (not shown). A second end of drill adapter 102 engages extension member 104 on the interior of extension member 104.

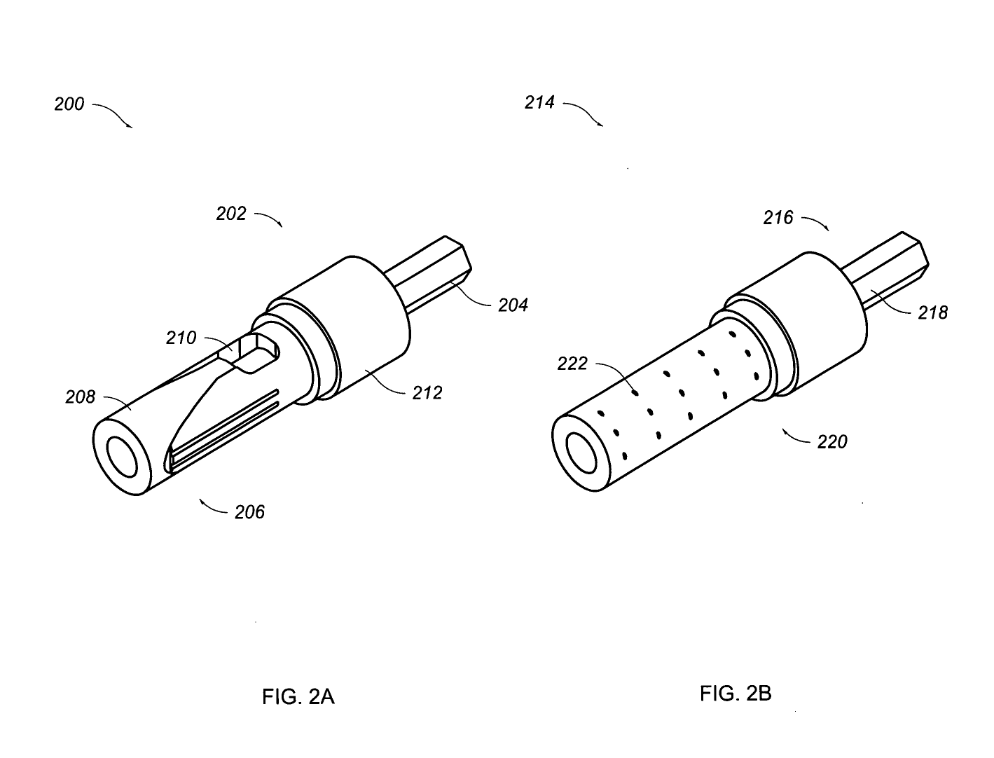

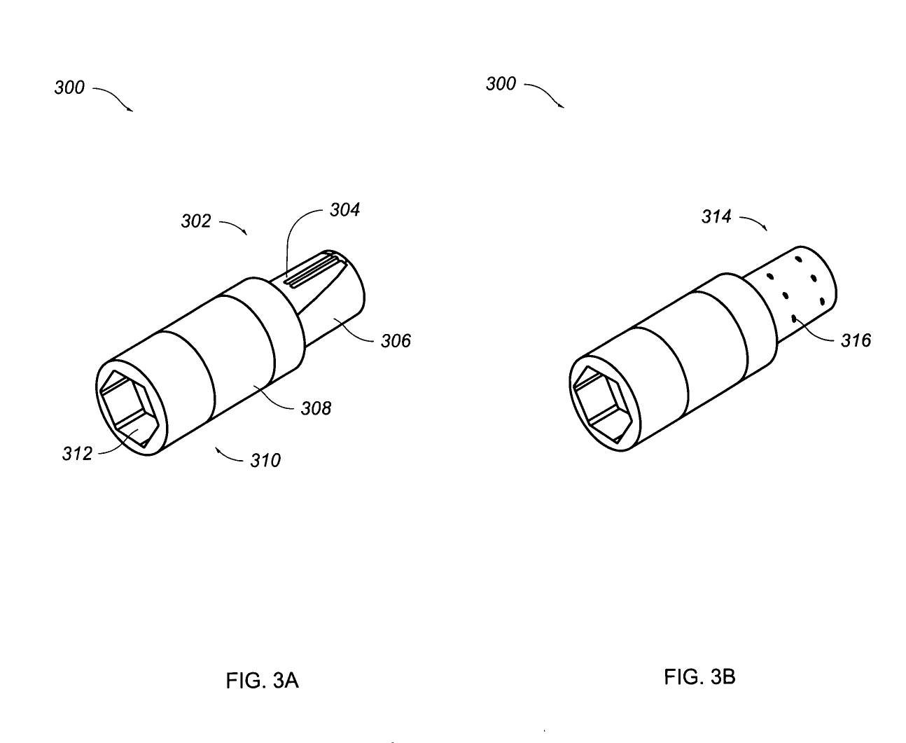

Extension member 104 also attaches to leading portion 106 in a similar manner. And engagement end (not shown) of leading portion 106 securely engages extension member 104 on the interior of extension member 104. Leading portion 106 also includes a receiving end 110, which holds one or more nuts. Drill adapter 102 and leading portion 106 are described in further detail with reference to FIGS. 2-3 below.

In operation, drill device 100 is attached to a drill and is used to place nuts at various positions along a length of threaded rod. Moreover, drill device 100 is configured to place nuts along threaded rods that may be several feet in length. Leading portion 106 is placed around the threaded rod, while drill adapter 102 is connected to a drill. As the drill is engaged, the drill rotates the drill device 100 upward along a portion of threaded rod. As leading portion 106 is moved up the length of the threaded rod, extension member 104 surrounds the threaded rod. Moreover, the extension member 104 can be moved up and down along the length of the threaded rod. In this way, the extension member 104 moveably engages the threaded rod—the extension member surrounds the rod, but can be moved up and down along the length of the rod.

When the nut has been placed at the appropriate height along the threaded rod, the drill motor is stopped and the leading portion 106 disengages the nut at the appropriate position along the threaded rod. As the drill is reversed and the drill device 100 is moved down the length of threaded rod, other nuts are placed in various positions along the threaded rod.

With attention now to FIG. 2A, a drill adapter 200 is shown. Drill adapter 200 includes a first end 202 having a hexagonal bolt, or hex-bolt, adapter 204 configured to engage a drill. Drill adapter 200 further includes a second end 206 configured to release-ably engage an extension member (not shown), such as extension member 104 shown in FIG. 1. In one embodiment of the invention, second end 206 includes engagement members 208 and 210 configured to engage an extension member. In one embodiment of the invention shown in FIG. 2A, engagement member 208 and 210 engage an extension member when engagement member 208 is pushed toward engagement member 210, thus causing engagement member 210 to expand against the interior of an extension member, thereby engaging the extension member. In one embodiment of the invention, engagement member 208 is pushed toward engagement member 210 when portion 212 of first end 202 is turned or rotated. Such a form of expansion engagement can be used with other portions of the invention for like purposes, such as, for example, engagement of an extension member. The expansion engagement arrangement of engagement members 208 and 210 is particularly useful for applications involving engagement of a cylindrical member from the inside.

An additional embodiment of a drill adapter is shown in FIG. 2B. Here, drill adapter 214 includes a first end 216 having a hexagonal bolt, or hex-bolt, adapter 218 configured to engage a drill. As with drill adapter 200, drill adapter 214 also includes a second end 220 configured to release-ably engage an extension member (not shown). Second end 220 includes teeth 222 located at various positions along second end 220. When second end 220 is inserted in an extension member, teeth 222 engage the inside of the extension member and hold the drill adapter 214 in place within the extension member. While the entire second end 220 is configured to fit snugly within an extension member, teeth 222 are further configured to secure the second end 220 against the inside of the extension member. In other embodiments of the invention, second end 220 includes raised bumps and or bands to securely engage the extension member. Moreover, drill adapter 214 may be configured of any suitable material, such as, for example, spring steel, or other metal, acrylonitrile butadiene styrene (ABS), polyvinyl chloride (PVC), or other plastic. Further, in certain embodiments of the invention drill adapter 214 is disposable such that after the drill adapter has been used for placing nuts on threaded rod, drill adapter 214 can be removed from an extension member and discarded. It is to be appreciated that second end 220 may take any form to engage an extension member with second end 220, while at the same time being configured to engage a drill at first end 216.

Like drill adapter 214, leading portion 300, as shown in FIG. 3A, also engages a cylindrical extension member. Here, leading portion 300, or nut retention end 300, includes a first end 302 configured to engage an extension member (not shown). Engagement members 304 and 306 are configured to engage the interior of an extension member. In operation, engagement member 304 expands within the interior of an extension member when portion 308 of drill adapter 300 is turned or rotated. The expansion of engagement member 304 is actuated by the movement of engagement member 306 toward engagement member 304. As portion 308 of the leading portion 300 is turned, engagement member 306 is moved toward engagement member 304, thus forcing ends of engagement member 304 outward. The expansion of engagement member 304 in this way engages the interior side of the extension member and secures drill adapter 300 to the extension member.

In addition to engagement member 304 and 306, leading portion 300 further includes second end 310. Second end 310 includes socket 312, which is configured to hold a nut.

In operation, first end 302 is connected to an extension member, which is further connected to a drill adapter and a drill (not shown). Second end 310, holding a nut, is placed on the end of a length of threaded rod. When the drill is actuated, second end 310, including the nut, is moved up the length of the threaded rod. When the nut reaches the desired location, the second end 310 disengages the nut and moves down the threaded rod to either place another nut or release the rod entirely. Thus, embodiments of the present invention provide a way to place nuts at various locations along a length of threaded rod. Embodiments of the present invention further enable placement of nuts at various locations along a piece of threaded rod that may be several feet in length without requiring disengagement of the rod between each placement of a nut. Moreover, embodiments of the present invention further enable use of an electric drill in placing nuts at various heights along lengthy sections of threaded rod.

As discussed above with respect to drill adapters suitable for use with the present invention, other configurations of leading portion 300 are contemplated by embodiments of the present invention. For example, leading portion 300 may be configured as a solid piece of material that is pushed into an end of an extension member. FIG. 3B shows such an embodiment of leading portion 300. Leading portion 300 includes a first end 314 configured to engage an extension member. First end 314 includes teeth 316, or other means for securely engaging an extension member. Such means for securely engaging an extension member includes any raised bump or band, or other raised portion, located on first end 314, configured such that when first end 314 is inserted into the extension member, the means for engaging securely holds the first end 314 of leading portion 300 in the extension member. While the first end 314 is sized to fit snugly within the extension member, the means for engaging the extension member further enhances the pressure exerted by the first end 314 on the interior of the extension member and secures the first end 314 to the extension member. Such means for securely engaging an extension member may also be included in embodiments of drill adapters 200 and 214, as outline above.

As with drill adapter 214, leading portion 300 may be configured of any suitable material, such as, for example, spring steel, steel, or other metal, acrylonitrile butadiene styrene (ABS), polyvinyl chloride (PVC), or other plastic. In one embodiment of the invention leading portion 300 is disposable so that leading portion 300 may be disengaged from an extension member and discarded.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An attachment device for a drill, comprising:
an extension member having a first end and a second end;
a drill adapter having a first end and a second end wherein the first end of the drill adapter is configured to attach to a drill and the second end of the drill adapter is configured to engage the extension member at the first end of the extension member; and
a leading portion having an engagement end configured to engage the extension member at the second end of the extension member, the engagement end of the leading portion being rotatably actuated to engage the extension member, the leading portion and the extension member being configured to movably engage a threaded rod, and the leading portion farther having a receiving end.

2. The device as recited in claim 1, wherein the first end of the drill adapter is one of: a socket; and, a hexagonal bolt.

3. The device as recited in claim 1, wherein the second end of the drill adapter is configured to securely engage the extension member.

4. The device as recited in claim 3, wherein the second end of the drill adapter is configured to securely engage the extension member by expanding within the extension member.

5. The device as recited in claim 1, wherein in the extension member is electrical conduit.

6. The device as recited in claim 5, wherein the extension member has a diameter sized large enough to surround a threaded rod having a diameter of one of: one fourth of one inch; three eighths of one inch; one half of one inch; five eights of one inch; and, three quarters of one inch.

7. The device as recited in claim 1, wherein the engagement end of the leading portion is configured to securely attach to the extension member by expanding within the extension member.

8. The device as recited in claim 1, wherein the receiving end of the leading portion is configured to hold one or more nuts.

9. The device as recited in claim 8, wherein the leading portion is configured to thread the one or more nuts into one or more positions along the threaded rod.

10. The device as recited in claim 1, wherein at least one of the second end of the drill adapter and the engagement end of the leading portion is sized to fit snugly within the extension member.

11. The device as recited in claim 10, wherein at least one of the second end of the drill adapter and the engagement end of the leading portion further includes teeth to securely engage the extension member.

12. The device as recited in claim 10, wherein at least one of the second end of the drill adapter and the engagement end of the leading portion further includes means for securely engaging the extension member.

13. The device as recited in claim 1, wherein at least one of the drill adapter and the leading portion is disposable.

14. The device as recited in claim 1, wherein at least one of the drill adapter and the leading portion is configured of one of: steel; spring steel; and, any other metal; acrylonitrile butadiene styrene; polyvinyl chloride; and, any other plastic.

15. A drill attachment device for placing nuts in various positions along a length of threaded rod, comprising:
a drill adapter, the drill adapter having a first end and a second end, wherein the first end is configured to attach to a drill;
an extension member, the extension member having a first end and a second end, wherein the first end of the extension member is removably engaged by the second end of the drill adapter;
a leading portion, wherein the leading portion includes a first end and a second end, the first end of the leading portion being configured to removably engage the second end of the extension member, wherein the first end of the leading portion is rotatably actuated to engage the second end of the extension member and the second end of the leading portion including an opening; and
the extension member and the leading portion being further configured to movably engage a threaded rod.

16. The device as recited in claim 10, wherein the first end of the drill adapter is one of: a socket; and, a hexagonal bolt.

17. The device as recited in claim 10, wherein the second end of the drill adapter is configured to expand within the first end of the extension member to securely engage the extension member.

18. The device as recited in claim 10, wherein the first end of the leading portion is configured to expand within the first end of the extension member to securely engage the extension member.

19. The device as recited in claim 10, wherein the extension member is electrical conduit.

20. The device as recited in claim 10, wherein the opening of the leading portion is configured to hold one or more nuts.
